(19) United States
(12) Patent Application Publication
(10) Pub. No.: US 2026/0351261 A1
(43) Pub. Date: Nov. 5, 2026

(54) METHOD AND APPARATUS FOR OPTIMIZING VOICEPRINT MODEL BASED ON REINFORCEMENT LEARNING, DEVICE, AND MEDIUM

(71) Applicant: PING AN TECHNOLOGY (SHENZHEN) CO., LTD., Shenzhen (CN)

(72) Inventors: Yayun HE, Shenzhen (CN); Junqing PENG, Shenzhen (CN); Jianzong WANG, Shenzhen (CN)

(73) Assignee: PING AN TECHNOLOGY (SHENZHEN) CO., LTD., Shenzhen (CN)

(21) Appl. No.: 19/693,295

(22) Filed: May 29, 2026

Related U.S. Application Data
(63) Continuation of application No. PCT/CN2025/135603, filed on Nov. 18, 2025.

(30) Foreign Application Priority Data
Apr. 18, 2025 (CN) 202510493314.8

(51) Int. Cl. G10L 17/18; G10L 17/04

(52) U.S. Cl. CPC G10L 17/18; G10L 17/04

(57) ABSTRACT

This application relates to the field of artificial intelligence, and discloses a method and apparatus for optimizing a voiceprint model based on reinforcement learning, a device, and a medium. To solve the technical problem that it is difficult to optimize a voiceprint model after deployment, the voiceprint model is optimized through reinforcement learning and KL divergence constraints, thereby improving stability and efficiency of policy update, reliably optimizing the voiceprint model, and improving recognition accuracy of the voiceprint model. The method and apparatus for optimizing a voiceprint model based on reinforcement learning, the device, and the medium can be used in application scenarios involving voiceprint model optimization in business system platforms of financial technology, healthcare, and the like.

### CROSS-REFERENCE TO RELATED APPLICATIONS

This application claims priority to the Chinese Patent Application No. 202510493314.8, filed with China National Intellectual Property Administration on Apr. 18, 2025, and entitled “METHOD AND APPARATUS FOR OPTIMIZING VOICEPRINT MODEL BASED ON REINFORCEMENT LEARNING, DEVICE, AND MEDIUM”, which is incorporated herein by reference in its entirety.

### TECHNICAL FIELD

This application relates to the field of artificial intelligence technology, and in particular, to a method and apparatus for optimizing a voiceprint model based on reinforcement learning, a device, and a medium.

### BACKGROUND

Voiceprint refers to speech features contained in a speech and capable of representing and identifying a speaker, while voiceprint recognition is a process of identifying the speaker corresponding to a speech to be recognized according to voiceprint features of the speech. Because of the particularity of sound, voiceprint recognition has unique physiological characteristics compared with other behavioral characteristics. Therefore, in theory, voiceprint is like a fingerprint, and very few people have the same voiceprint features. This characteristic makes the voiceprint recognition technology as a new means of identity verification show great potential in risk prevention and control and customer identity verification in many fields.

In the field of healthcare, voiceprint recognition can be applied to telemedicine consultation. For example, a patient communicates with a doctor about his/her condition via a video or voice call. To ensure the authenticity of the patient's identity and information security, the patient's identity can be verified by using a voiceprint recognition model. Voiceprint recognition can also be applied, for example, in the verification of operating permissions for a high-precision medical device. That is, the identity of an operator can be verified through voiceprint recognition to ensure that the operator possesses corresponding qualifications and permissions.

In the financial field, voiceprint recognition can be applied to telephone service scenarios such as insurance business or banking business. When a customer handles business by telephone, the identity of the customer is verified by using a voiceprint recognition model to ensure transaction security. Alternatively, in the process of reporting insurance claims, the voiceprint model enables an insurance company to verify the identity of the customer more accurately, to reduce misjudgment and fraud.

However, the inventor has realized that voiceprint models still have some shortcomings in practical application. In a conventional technology or a technology, once a voiceprint model is deployed, it is highly difficult to optimize the model, and there is a lack of effective optimization means against misjudgment cases. Retraining the voiceprint model may cause the model to forget previously learned knowledge, and then affect original correct determination cases. As a result, the voiceprint recognition model may not be adjusted in a timely manner when confronted with new speech features or a complex speech environment, thereby affecting the recognition accuracy.

### SUMMARY

In view of the shortcomings of the prior art mentioned above, an objective of this application is to provide a method and apparatus for optimizing a voiceprint model based on reinforcement learning, a device, and a medium, which can be applied to the medical field, financial technology, or other related fields. A main objective thereof is to improve recognition accuracy of a voiceprint model by efficiently and reliably optimizing the voiceprint model.

The technical solutions of this application are as follows:

A first aspect of this application provides a method for optimizing a voiceprint model based on reinforcement learning, including:
collecting historical recognition cases of a voiceprint model, and constructing an optimization dataset according to the historical recognition cases;
randomly initializing a policy network, sampling audio data from the optimization dataset, inputting the audio data into the voiceprint model, and controlling the voiceprint model to perform voiceprint recognition according to an initialization policy, to obtain a recognition result and a corresponding reward value for each sample;
calculating an advantage function according to the recognition result and the reward value for each sample, and performing parameter update on the policy network based on the advantage function;
optimizing a pre-constructed objective function according to parameters of the policy network before and after the update, the objective function including a KL divergence term for constraining a policy update magnitude;
repeatedly executing the process of audio data sampling, voiceprint recognition, and policy update until the objective function satisfies a preset condition, to obtain an optimal policy network; and
controlling the voiceprint model to perform voiceprint recognition according to an optimal policy based on the optimal policy network, to optimize a recognition result.

A second aspect of this application provides an apparatus for optimizing a voiceprint model based on reinforcement learning, including:
a data collection module, configured to collect historical recognition cases of a voiceprint model, and construct an optimization dataset according to the historical recognition cases;
an initialization module, configured to randomly initialize a policy network, sample audio data from the optimization dataset, input the audio data into the voiceprint model, and control the voiceprint model to perform voiceprint recognition according to an initialization policy, to obtain a recognition result and a corresponding reward value for each sample;
a policy update module, configured to calculate an advantage function according to the recognition result and the reward value for each sample, and perform parameter update on the policy network based on the advantage function;
a function optimization module, configured to optimize a pre-constructed objective function according to parameters of the policy network before and after the update, the objective function including a KL divergence term for constraining a policy update magnitude;
an iteration control module, configured to repeatedly execute the process of audio data sampling, voiceprint recognition, and policy update until the objective function satisfies a preset condition, to obtain an optimal policy network; and
a model optimization module, configured to control the voiceprint model to perform voiceprint recognition according to an optimal policy based on the optimal policy network, to optimize a recognition result.

A third aspect of this application provides a computer device, including at least one processor; and
a memory in communication connection with the at least one processor, where
the memory stores instructions executable by the at least one processor, and the instructions are executed by the at least one processor, to enable the at least one processor to perform the following steps of the above-described method for optimizing a voiceprint model based on reinforcement learning:
collecting historical recognition cases of a voiceprint model, and constructing an optimization dataset according to the historical recognition cases;
randomly initializing a policy network, sampling audio data from the optimization dataset, inputting the audio data into the voiceprint model, and controlling the voiceprint model to perform voiceprint recognition according to an initialization policy, to obtain a recognition result and a corresponding reward value for each sample;
calculating an advantage function according to the recognition result and the reward value for each sample, and performing parameter update on the policy network based on the advantage function;
optimizing a pre-constructed objective function according to parameters of the policy network before and after the update, the objective function including a KL divergence term for constraining a policy update magnitude;
repeatedly executing the process of audio data sampling, voiceprint recognition, and policy update until the objective function satisfies a preset condition, to obtain an optimal policy network; and
controlling the voiceprint model to perform voiceprint recognition according to an optimal policy based on the optimal policy network, to optimize a recognition result.

A fourth aspect of this application provides a nonvolatile computer-readable storage medium, where the nonvolatile computer-readable storage medium stores computer-executable instructions and the computer-executable instructions, when executed by one or more processors, cause the one or more processors to perform the above-mentioned method for optimizing a voiceprint model based on reinforcement learning.

Beneficial effects: This application discloses the method and apparatus for optimizing a voiceprint model based on reinforcement learning, the device, and the medium. Compared with the prior art, the method for optimizing a voiceprint model based on reinforcement learning according to embodiments of this application includes: collecting historical recognition cases of a voiceprint model, and constructing an optimization dataset according to the historical recognition cases; randomly initializing a policy network, sampling audio data from the optimization dataset, inputting the audio data into the voiceprint model, and controlling the voiceprint model to perform voiceprint recognition according to an initialization policy, to obtain a recognition result and a corresponding reward value for each sample; calculating an advantage function according to the recognition result and the reward value for each sample, and performing parameter update on the policy network based on the advantage function; optimizing a pre-constructed objective function according to parameters of the policy network before and after the update, the objective function including a KL divergence term for constraining a policy update magnitude; repeatedly executing the process of audio data sampling, voiceprint recognition, and policy update until the objective function satisfies a preset condition, to obtain an optimal policy network; and controlling the voiceprint model to perform voiceprint recognition according to an optimal policy based on the optimal policy network, to optimize a recognition result. The voiceprint model is optimized through reinforcement learning and KL divergence constraints, thereby improving stability and efficiency of policy update, reliably optimizing the voiceprint model, and improving recognition accuracy of the voiceprint model.

### BRIEF DESCRIPTION OF DRAWINGS

To describe the solutions in this application more clearly, the following briefly describes the accompanying drawings required for describing the embodiments of this application. Clearly, the accompanying drawings in the following description show some embodiments of this application, and those of ordinary skill in the art may still derive other accompanying drawings from these accompanying drawings without creative efforts.

FIG. 1 is a schematic diagram of an application environment for a method for optimizing a voiceprint model based on reinforcement learning according to an embodiment of this application;

FIG. 2 is a flowchart of a method for optimizing a voiceprint model based on reinforcement learning according to an embodiment of this application;

FIG. 3 is a flowchart of step S201 in a method for optimizing a voiceprint model based on reinforcement learning according to an embodiment of this application;

FIG. 4 is a flowchart of step S202 in a method for optimizing a voiceprint model based on reinforcement learning according to an embodiment of this application;

FIG. 5 is a flowchart of step S203 in a method for optimizing a voiceprint model based on reinforcement learning according to an embodiment of this application;

FIG. 6 is a flowchart of step S204 in a method for optimizing a voiceprint model based on reinforcement learning according to an embodiment of this application;

FIG. 7 is a schematic functional block diagram of an apparatus for optimizing a voiceprint model based on reinforcement learning according to an embodiment of this application; and

FIG. 8 is a schematic hardware structure diagram of a computer device according to an embodiment of this application.

### DETAILED DESCRIPTION OF THE EMBODIMENTS

To make the objectives, technical solutions, and effects of this application clearer, the following further describes this application in detail. It should be understood that the specific embodiments described herein are merely used to explain this application but are not intended to limit this application. Embodiments of this application are described below with reference to the accompanying drawings.

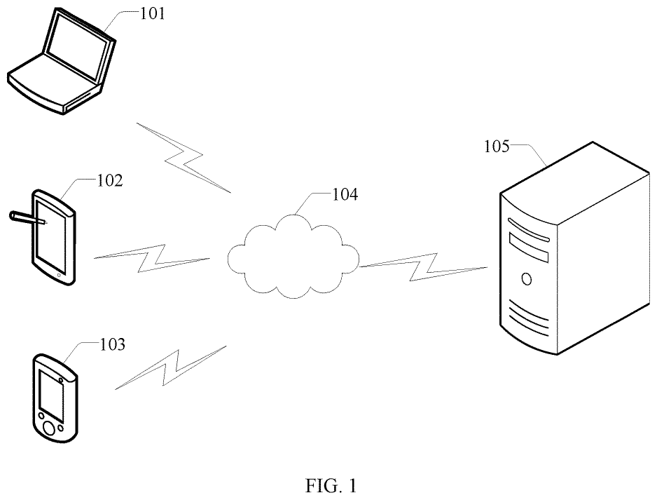

A method for optimizing a voiceprint model based on reinforcement learning according to an embodiment of this application can be applied in an application environment shown in FIG. 1, which includes a first terminal device 101, a second terminal device 102, a third terminal device 103, a network 104, and a server 105. The network 104 is a medium configured to provide communication links among the first terminal device 101, the second terminal device 102, the third terminal device 103, and the server 105. The network 104 may include various connection types, such as a wired communication link and/or a wireless communication link.

A user may use the first terminal device 101, the second terminal device 102 and the third terminal device 103 to interact with the server 105 via the network 104, to receive or send a message, etc. Various communication client applications, such as knowledge reading applications, web browser applications, search applications, instant messaging tools, email clients and/or social platform software (as examples only), can be installed on the first terminal device 101, the second terminal device 102, and the third terminal device 103.

The first terminal device 101, the second terminal device 102, and the third terminal device 103 may be various electronic devices each having a display screen and supporting web browsing, including but not limited to smart phones, tablet computers, laptop computers, desktop computers, and the like.

The server 105 may be a server that provides various services, such as a backend server (as an example only) that provides support for content browsed by a user using the first terminal device 101, the second terminal device 102, and the third terminal device 103. The backend server may perform analysis and other processing on data such as a received user request, and feed back a processing result (for example, a web page, information, or data obtained or generated based on the user request) to a terminal device. The server 105 may be a cloud server, also known as a cloud computing server or a cloud host, and is a host product in a cloud computing service system, so as to solve the shortcomings of high management difficulty and weak business scalability of a conventional physical host and a virtual private server (VPS) service. The server 105 may alternatively be a server of a distributed system or a server combined with a blockchain.

It should be noted that the method for optimizing a voiceprint model based on reinforcement learning according to the embodiment of this application can generally be executed by the first terminal device 101, the second terminal device 102 or the third terminal device 103. Correspondingly, an apparatus for optimizing a voiceprint model based on reinforcement learning according to an embodiment of this application can also be arranged in the first terminal device 101, the second terminal device 102 or the third terminal device 103. Alternatively, the method for optimizing a voiceprint model based on reinforcement learning according to the embodiment of this application can generally be performed by the server 105. Correspondingly, the apparatus for optimizing a voiceprint model based on reinforcement learning according to the embodiment of this application can generally be arranged in the server 105.

It should be understood that the numbers of terminal devices, networks, and servers above are merely illustrative. According to implementation needs, there may be any number of terminal devices, any number of networks, and any number of servers.

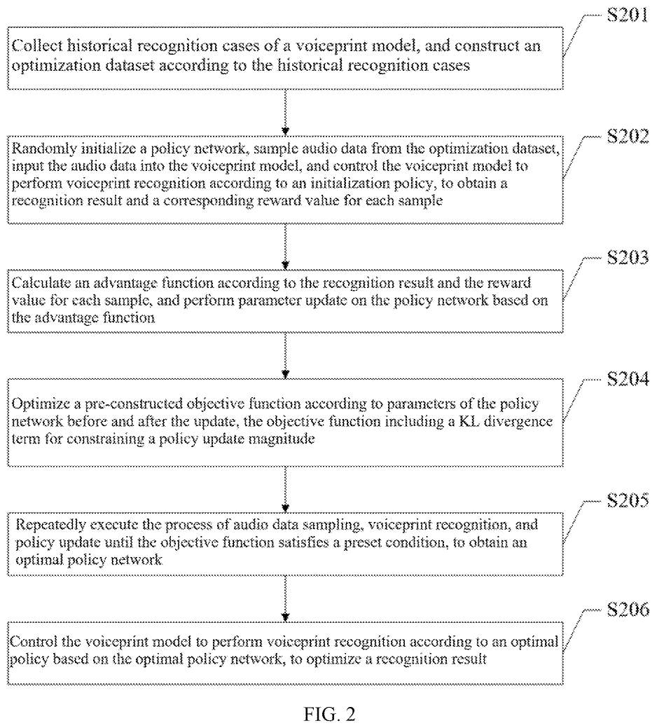

As shown in FIG. 2, a method for optimizing a voiceprint model based on reinforcement learning according to an embodiment of this application specifically includes the following steps:

S201: Collect historical recognition cases of a voiceprint model, and construct an optimization dataset according to the historical recognition cases.

In this embodiment, in order to optimize an existing voiceprint model, historical recognition cases of the voiceprint model are collected from an actual business scenario (such as a medical consultation scenario and a financial insurance scenario), and corresponding historical recognition cases are collected based on audio data processed by voiceprint model in an actual business application and corresponding recognition results. These historical recognition cases include correct recognition cases and incorrect recognition cases. By collecting these historical recognition cases, a case dataset containing correct recognition and incorrect recognition is constructed for subsequent model optimization training, thereby providing a foundation for continuous model improvement. Preferably, in addition to directly using the historical recognition cases, more diverse training data can be generated through data augmentation (such as noise addition, pitch adjustment, and speed variation) to comprehensively cover various situations that the model may encounter in practical applications, thereby enhancing the generalization capability of the model.

For example, in a healthcare scenario (e.g., telemedicine consultation), voiceprint recognition results during calls between patients and doctors are collected, including cases of correct patient identity recognition and misjudgment cases, and the like, to construct an optimization dataset. In a financial scenario, for example, in an insurance claims service, voiceprint recognition results generated when customers handle claims business are collected, including cases of correct customer identity recognition and misjudgment cases, and the like, to construct an optimization dataset. In addition, more diverse training data can also be generated by a data augmentation method such as adding background noise.

S202: Randomly initialize a policy network, sample audio data from the optimization dataset, input the audio data into the voiceprint model, and control the voiceprint model to perform voiceprint recognition according to an initialization policy, to obtain a recognition result and a corresponding reward value for each sample.

In this embodiment, the policy network is a deep learning model, such as a convolutional neural network (CNN), a recurrent neural network (RNN) or another network structure suitable for processing audio data. The policy network is configured to output a decision policy of the voiceprint model, and parameters of the policy network determine how the voiceprint model recognizes and determines input audio data, that is, recognizes whether the input audio data and reference audio (such as audio inputted by a customer in advance) belong to a same person. During optimization of the voiceprint model, the parameters of the policy network are first randomly initialized, and a batch of audio data is randomly sampled from the optimization dataset as samples to be inputted into the voiceprint model. For each input sample, the voiceprint model performs voiceprint recognition based on the initialization policy corresponding to the current policy network, thereby obtaining the recognition result and the corresponding reward value for each sample, and providing corresponding feedback signals for subsequent policy update.

The reward value is obtained by a reward function predefined based on business requirements. For example, a positive reward (such as +1) is provided when the voiceprint model implements correct recognition, and a negative reward (such as −1) is provided when the voiceprint model implements incorrect recognition. By designing positive and negative reward functions, the model can learn from correct recognition and incorrect recognition cases and feed back an update policy, thereby effectively improving recognition accuracy. Definitely, in another embodiment, another reward function may alternatively be adopted to obtain a reward value, such as providing different levels of negative rewards according to the severity of misjudgment, or providing rewards according to recognition confidence. This is not limited in this embodiment.

For example, in a telemedicine consultation scenario, after the policy network is randomly initialized, audio data from doctor-patient calls is sampled from the optimization dataset and inputted into the voiceprint model. Reward values are calculated according to recognition results. For example, a reward of +1 is provided when the voiceprint model correctly recognizes the identity of a patient from the input audio, while a reward of −1 is provided for misjudgment. For another example, in a scenario of claims reporting or telephone banking in the financial field, after the policy network is randomly initialized, audio data of a customer handling business by telephone is sampled from the optimization dataset and inputted into the voiceprint model. If the voiceprint model can accurately recognize the identity of the customer, a reward of +1 is provided, or a reward of −1 is provided for misjudgment.

S203: Calculate an advantage function according to the recognition result and the reward value for each sample, and perform parameter update on the policy network based on the advantage function.

In this embodiment, the advantage function refers to measuring the advantage of a return obtained by taking an action under a given state relative to an average return. Specifically, the advantage function may be estimated using a method such as generalized advantage estimation (GAE), Monte Carlo tree search (MCTS), or temporal difference (TD) learning. This is not limited in this embodiment. Since the advantage function can more accurately evaluate the advantages and disadvantages of each action, in this embodiment, the advantage function is calculated based on the recognition result and the reward value for each sample, and the parameters of the policy network are adjusted according to a value of the advantage function. That is, the policy improvement is guided by the advantage function, and sampled data is fully utilized, so that the model is more inclined to take actions with greater advantages, thereby updating the policy network more effectively to optimize a recognition effect of the voiceprint model.

S204: Optimize a pre-constructed objective function according to parameters of the policy network before and after the update, the objective function including a KL divergence term for constraining a policy update magnitude.

In this embodiment, an objective function is pre-constructed to calculate an expected value of a cumulative reward to evaluate the performance of the policy network, and a corresponding value of the objective function is calculated based on the parameters of the policy network before the update and the parameters of the policy network after the update. Whether the performance of the policy network is improving is evaluated based on the value of the objective function, so that the entire optimization process is guided by maximizing the expected value of the cumulative reward, and the learning direction of the policy network is ensured to advance towards maximizing the cumulative reward. By optimizing the objective function, it is ensured that the policy network can learn an optimal policy, thereby improving the performance of the voiceprint recognition model. In addition, to prevent an excessive policy update magnitude that would cause the model to forget previously learned knowledge and then affect original correct judgment cases, the objective function pre-constructed in this embodiment includes a KL divergence term. KL divergence specifically refers to Kullback-Leibler divergence, which is an asymmetric measure of a difference between two probability distributions and is used to quantify the difference between the two probability distributions. By restricting the KL divergence between an old policy and a new policy, a moderate magnitude of policy update is ensured, and the stability of the model during the optimization process is improved.

S205: Repeatedly execute the process of audio data sampling, voiceprint recognition, and policy update until the objective function satisfies a preset condition, to obtain an optimal policy network.

The above processes of sampling, recognition, calculation of the advantage function, updating of the policy network, and calculation of the objective function are repeated until the objective function satisfies a certain convergence condition, for example, the parameter updating magnitude of the policy network is less than a threshold, or the value of the objective function reaches a stable value, or a preset number of iterations are reached, so as to obtain the optimal policy network.

That is, in each iteration, the policy network chooses an action according to latest parameters to guide the voiceprint recognition model to recognize audio data. Through iteration, the policy network is optimized step by step to achieve the optimal performance after multiple updates. Specifically, in an initial stage, the parameters of the policy network are randomly initialized, so an action selected thereby may not be ideal. In this case, the voiceprint model has poor performance. In an intermediate stage, with the continuous updating of the policy network, a more reasonable action is selected after each update, so as to gradually improve the performance of the voiceprint recognition model. In a convergence stage, when the parameters of the policy network converge to an optimal state, an optimal action is selected, and the behavior of the voiceprint recognition model is dynamically adjusted based on the optimization method of reinforcement learning, so as to maximize the performance of the voiceprint recognition model.

S206: Control the voiceprint model to perform voiceprint recognition according to an optimal policy based on the optimal policy network, to optimize a recognition result.

In this embodiment, after multiple iterative optimizations, the policy network with optimal performance is finally obtained. The optimized policy network is deployed in practical applications for a voiceprint recognition task, so that the optimization of the voiceprint recognition model is guided by the optimal policy, thereby optimizing the recognition results of the model, and enhancing the accuracy and reliability of voiceprint recognition. The method for optimizing a voiceprint model based on reinforcement learning and KL divergence constraints is especially suitable for remote identity verification scenarios in insurance business, such as claims reporting and telephone sales. This can quickly recognize the identity of a customer, reduce misjudgment and fraud, and improve customer experience and service quality.

In the above embodiment, this application discloses a method for optimizing a voiceprint model based on reinforcement learning, including: collecting historical recognition cases of a voiceprint model, and constructing an optimization dataset according to the historical recognition cases; randomly initializing a policy network, sampling audio data from the optimization dataset, inputting the audio data into the voiceprint model, and controlling the voiceprint model to perform voiceprint recognition according to an initialization policy, to obtain a recognition result and a corresponding reward value for each sample; calculating an advantage function according to the recognition result and the reward value for each sample, and performing parameter update on the policy network based on the advantage function; optimizing a pre-constructed objective function according to parameters of the policy network before and after the update, the objective function including a KL divergence term for constraining a policy update magnitude; repeatedly executing the process of audio data sampling, voiceprint recognition, and policy update until the objective function satisfies a preset condition, to obtain an optimal policy network; and controlling the voiceprint model to perform voiceprint recognition according to an optimal policy based on the optimal policy network, to optimize a recognition result. The voiceprint model is optimized through reinforcement learning and KL divergence constraints, thereby improving stability and efficiency of policy update, reliably optimizing the voiceprint model, and improving recognition accuracy of the voiceprint model.

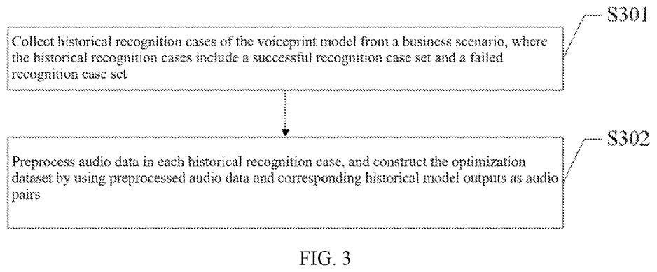

In one embodiment, as shown in FIG. 3, step S201 includes the following substeps:

S301: Collect historical recognition cases of the voiceprint model from a business scenario, where the historical recognition cases include a successful recognition case set and a failed recognition case set.

S302: Preprocess audio data in each historical recognition case, and construct the optimization dataset by using preprocessed audio data and corresponding historical model outputs as audio pairs.

In this embodiment, when the dataset is constructed, data is collected from a practical application environment for the voiceprint model, such as a business scenario like telemedicine consultation or telephone banking service. In these scenarios, a large amount of voiceprint recognition data is accumulated. Recognition records of the voiceprint model, including audio files and model output results, are extracted from an actual business system. Each case is labeled to clarify whether the case is a successful case or a failed case. The historical recognition cases are classified into two types: a successful recognition case set and a failed recognition case set, namely cases where the model correctly recognizes whether audio pairs belong to a same person, and cases where the model incorrectly recognizes whether audio pairs belong to a same person. By collecting both successful and failed cases, the dataset can comprehensively cover various situations that the model may encounter in practical applications, thereby providing rich data support for subsequent optimization.

Then the audio data in the historical recognition cases are correspondingly preprocessed to improve the data quality and enhance the training effect of the model. Specifically, preprocessing methods such as sampling and quantization, pre-emphasis, windowing, and noise removal may be adopted. The sampling and quantization are to convert audio signals into digital signals and adjust a sampling rate to adapt to a model input. The pre-emphasis is to enhance high-frequency signals and reduce the loss of high-frequency signals during transmission. The windowing is to divide an audio signal into a plurality of short-time windows to facilitate analysis. The noise removal is to remove background noise by filtering and other methods to improve the clarity of audio signals. The preprocessed audio data and the historical output of the model (namely a previous recognition result of the model) are combined into a data pair. For example, for an audio pair, the historical output of the model may be “a same person” or “different persons”. Such historical output may be either correct judgment or incorrect judgment. That is, the case belongs to the successful recognition case set or the failed recognition case set. This provides high-quality training data for the optimization of voiceprint model, ensures the diversity and pertinence of the data, and lays a solid foundation for the subsequent model optimization.

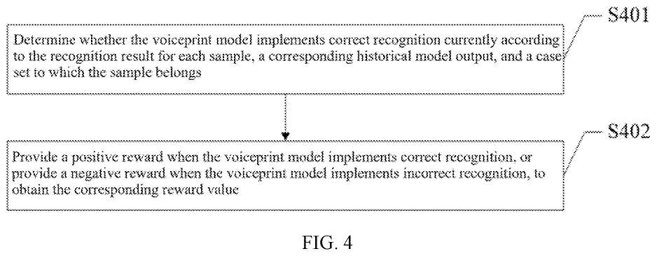

In one embodiment, as shown in FIG. 4, step S202 includes the following substeps:

S401: Sample audio pairs from the optimization dataset, input the audio data in the audio pairs into the voiceprint model, and control the voiceprint model to recognize, according to the initialization policy, whether the audio data and corresponding reference audio belong to a same person, to obtain the recognition result for each sample.

S402: Determine whether the voiceprint model implements correct recognition currently according to the recognition result for each sample, a corresponding historical model output, and a case set to which the sample belongs.

S403: Provide a positive reward when the voiceprint model implements correct recognition, or provide a negative reward when the voiceprint model implements incorrect recognition, to obtain the corresponding reward value.

In this embodiment, audio pairs (s, a) are sampled from the optimization dataset as training samples, where s is the input audio data (including audio to be recognized and judged and corresponding reference audio) and a is the historical output of the model (namely a previous recognition result of the voiceprint model in a business application). Specifically, methods such as random sampling and stratified sampling may be adopted to ensure the diversity and representativeness of the samples. The sampled audio data is inputted into the voiceprint model. The voiceprint model recognizes the input audio data according to the initialization policy and outputs a judgment result indicating whether the audio pair belongs to a same person. That is, the recognition result for each sample is obtained, thereby achieving the initial performance of the model and providing a foundation for subsequent reward calculation and policy update. Then, by comparing the current recognition result with the historical output of the model and with reference to the case set to which the sample belongs, it is determined whether the current recognition is correct. A corresponding reward value is provided based on a preset reward function, and the reward value is associated with the recognition result for each sample. Specifically, when the voiceprint model correctly recognizes whether the audio pair belongs to a same person, a positive reward value (e.g., +1) is provided, indicating that the decision of the model is correct. When the voiceprint model incorrectly recognizes whether the audio pair belongs to a same person, a negative reward value (e.g., −1) is provided, indicating that the decision of the model is incorrect. Through positive and negative reward values, clear feedback signals are provided to the model, helping the model learn a correct decision mode. The reward values serve as guidance for optimization, steering the model to be more inclined to make a correct decision in subsequent training.

Specifically, when it is determined whether the current recognition result of the voiceprint model is correct, if the current recognition result is consistent with the historical output and the sample belongs to the successful recognition case set (that is, the model correctly recognizes whether the two pieces of audio belong to a same person), it is determined that the recognition is correct. If the current recognition result is inconsistent with the historical output, and the sample belongs to the successful recognition case set (that is, the model incorrectly determines whether the two pieces of audio belong to a same person), it is determined that the recognition is incorrect. If the current recognition result is inconsistent with the historical output, and the sample belongs to the failed recognition case set (that is, the model corrects the previous incorrect recognition), it is determined that the recognition is correct. If the current recognition result is consistent with the historical output, and the sample belongs to the failed recognition case set (that is, the model still incorrectly recognizes whether the audio pair belongs to a same person), it is determined that the recognition is incorrect. Through this judgment logic, whether the current recognition result of the model is correct can be clearly reflected, targeted optimization is facilitated, and the model is helped to learn to correct previous errors and avoid forgetting previously correctly recognized cases, thereby improving the overall performance of the model.

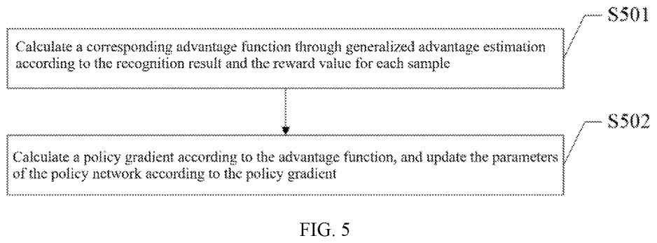

In one embodiment, as shown in FIG. 5, step S203 includes the following substeps:

S501: Calculate a corresponding advantage function through generalized advantage estimation according to the recognition result and the reward value for each sample.

S502: Calculate a policy gradient according to the advantage function, and update the parameters of the policy network according to the policy gradient.

In this embodiment, after the voiceprint model recognizes each sampled audio pair and obtains a corresponding reward value (positive reward or negative reward) according to whether the recognition result is correct, the corresponding advantage function is calculated through generalized advantage estimation. The generalized advantage estimation (GAE) is a method for calculating the advantage function, and balances a bias and a variance by combining multi-step temporal difference errors, so as to improve the accuracy and stability of advantage function estimation. Specifically, the advantage function A(s, a) is calculated by the following formula:

$$A ( s , a ) = {\sum }_{t = 0}^{T - 1} {( γ λ )}^{t} ( {R}_{t + 1} + γ V ( {s}_{t + 1} ) - V ( {s}_{t} ) )$$

where γ is a discount factor, λ is a GAE parameter, V(sₜ) is an estimated value of a value function for processing a t^{th} sample, V(sₜ₊₁) is an estimated value of the value function for processing a (t+1)^{th} sample, T is a total number of samples for calculating the advantage function, and Rₜ₊₁ is a reward value obtained by processing the (t+1)^{th} sample. By adjusting the GAE parameter λ, the bias-variance tradeoff of the GAE is controlled. When λ=0, GAE degenerates into one-step advantage estimation, and when λ=1, the GAE approximates Monte Carlo estimation, thereby effectively reducing the variance in the process of policy update and improving the stability of training.

Based on the calculated advantage function, the parameters of the policy network are updated by the policy gradient method. The policy gradient method updates the parameters of the policy network by computing the policy gradient. Specifically, derivatives of outputs (action probabilities) of the policy network with respect to the parameters are first calculated, the derivatives of the action probabilities are multiplied by the advantage function, and then the expectation over all states and actions is taken, to obtain the policy gradient. The parameters of the policy network are updated by a gradient ascent method according to the calculated policy gradient. During the update process, a learning rate is added to control the step size of the parameter update, enabling the policy network to be gradually more inclined to take high-reward actions. As a result, in subsequent decisions, the policy network is more inclined to take actions with greater advantages, to improve the performance of the policy network, and the policy network selects better actions in a voiceprint recognition task, thereby enhancing the performance of the voiceprint recognition model.

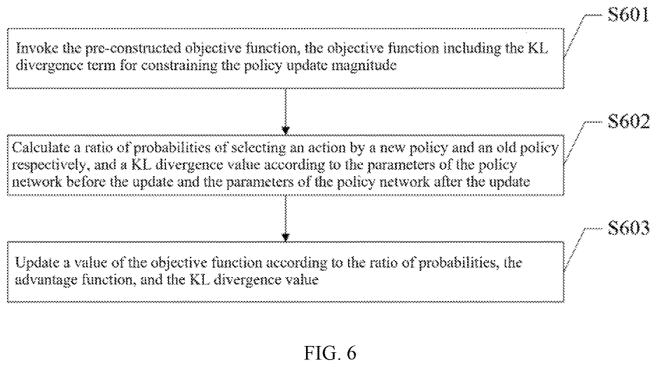

In one embodiment, as shown in FIG. 6, step S204 includes the following substeps:

S601: Invoke the pre-constructed objective function, the objective function including the KL divergence term for constraining the policy update magnitude.

S602: Calculate a ratio of probabilities of selecting an action by a new policy and an old policy respectively, and a KL divergence value according to the parameters of the policy network before the update and the parameters of the policy network after the update.

S603: Update a value of the objective function according to the ratio of probabilities, the advantage function, and the KL divergence value.

In this embodiment, the objective function including the KL divergence term is predefined. After each update of the policy network based on the advantage function, the objective function is invoked to calculate the value of the objective function corresponding to the current policy adjustment, so as to evaluate each update of the policy network, ensure that the policy network is moving in the direction of maximizing cumulative rewards, and ensure that the policy network can learn the optimal policy by updating and optimizing the objective function. Specifically, the predefined objective function is:

L(θ)= [symbol] _{s,a}[min(r(θ)·A(s,a),clip(r(θ),1−ε,1+ε)·A(s,a))]−β·D_{KL}(π_{θ}_{_{old}}∥π_{θ})

Where

$$r ( θ ) = \frac{{π}_{{θ}_{old}} ( a \vert s )}{{π}_{θ} ( a \vert s )}$$

is a ratio of probabilities, ε is a truncation parameter, D_{KL}(π_{θ}_{_{old}}∥π_{θ}) is KL divergence, β is a weight parameter of the KL divergence, π_{θ}_{_{old}} is an old parameter of the policy network, π_{θ} is a new parameter of the policy network, π_{θ}_{_{old}}(a|s) is an output of the policy network under the old parameter, namely a probability of taking action a in the state s, π_{θ}(a|s) is an output of the policy network under the new parameter, namely a probability of taking action a in the state s under the new policy, and clip is a clipping function.

That is, when the objective function is optimized, the ratio of probabilities of selecting an action by a new policy and an old policy respectively, and a KL divergence value are calculated according to the parameters of the policy network before the update and the parameters of the policy network after the update, where the ratio of probabilities refers to a ratio of probabilities of choosing a same action by a new policy and an old policy and is used to measure a change in preference for the same action before and after the policy update. The KL divergence value measures the difference between old and new policy distributions and is used to evaluate the magnitude of the policy update. By calculating the ratio of probabilities, the change in preference for the same action before and after the policy update can be visually evaluated. By calculating the KL divergence value, the magnitude of the policy update can be quantified, thereby providing a basis for subsequent update to the objective function. This restricts the magnitude of the policy update and prevents excessive parameter update that would cause forgetting. Subsequently, the value of the objective function is updated according to the ratio of probabilities, the advantage function, and the KL divergence value in accordance with the foregoing formula. The performance of the policy network is evaluated by the objective function containing the expectation of reward values and the KL divergence term, which provides guidance for the optimization of the policy network and ensures that the parameters of the policy network are adjusted in the optimization direction.

In one embodiment, the method further includes:
obtaining pre-constructed validation set data;
evaluating performance of the voiceprint model by using the validation set data according to a preset evaluation policy; and
dynamically adjusting, according to a performance evaluation result, a reward function for calculating the reward value.

In this embodiment, after the voiceprint model is optimized based on reinforcement learning and KL divergence constraints, the performance of the voiceprint model is evaluated. For example, the performance of the voiceprint model is evaluated according to a fixed time period, or performance evaluation is performed according to the data processing amount of the voiceprint model when the processed data reaches a preset number, so as to ensure that the performance of the voiceprint model always satisfies business requirements. Specifically, firstly, the validation set data is collected from an actual business scenario or generated by a method such as data augmentation. A validation set is a set of samples independent of training data, and is used to evaluate the performance of the model on unseen data. By obtaining the pre-constructed validation set data, an independent evaluation environment is provided, and the performance of the model can be evaluated more objectively. Based on the validation set data, the performance of the voiceprint model is evaluated according to the preset evaluation policy. For example, the validation set data is inputted into the voiceprint model for recognition. After the recognition results are obtained, corresponding evaluation metrics, such as accuracy, recall, and F1 score, are calculated, to determine whether the evaluation metrics meet a preset metric threshold. Multiple evaluation metrics are adopted to comprehensively evaluate the model performance on the validation set, thereby ensuring reliability and effectiveness of the model in practical application. This also enables timely detection of performance changes to further optimize model performance.

Further, with the optimization and performance evaluation of the voiceprint model, the reward function used to calculate the reward value is dynamically adjusted according to performance evaluation results in different model stages, to optimize the training direction of the model. Specifically, a magnitude of a positive reward is correspondingly reduced and a magnitude of a negative reward is increased when the performance of the voiceprint model is improved; or correspondingly increasing the magnitude of the positive reward and reducing the magnitude of the negative reward when the performance of the voiceprint model is degraded. For example, when the evaluated accuracy or recall of the model is low, the magnitude of the positive reward can be increased and the magnitude of the negative reward can be reduced. Because the performance of the model is different in different stages, the magnitude and distribution of reward values can be adjusted according to the current performance of the mode by dynamically adjusting the reward function, to make the model more suitable for the training needs of the model, so that the model can pay attention to different optimization objectives in different stages and better balance the accuracy and recall of the model, thereby improving the overall performance of the model.

It should be noted that there is not necessarily a certain sequence between the above steps. According to the description of the embodiments of this application, those of ordinary skill in the art can understand that in different embodiments, the above steps can be performed in different sequences. That is, they can be performed in parallel, interchangeably, or in other sequences.

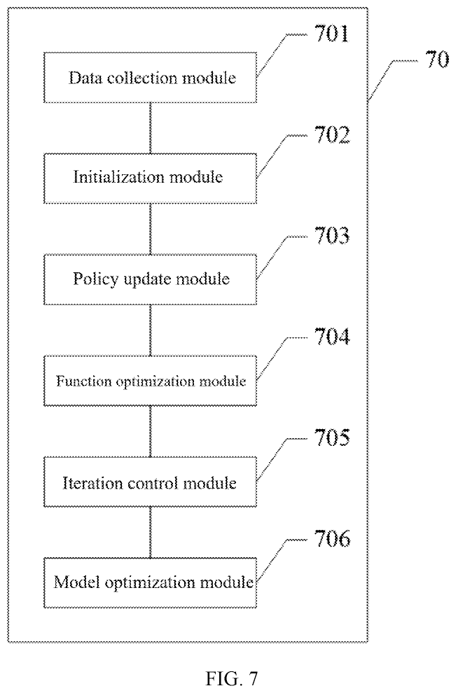

Further referring to FIG. 7, as an implementation of the method shown in FIG. 2, this application provides an embodiment of an apparatus for optimizing a voiceprint model based on reinforcement learning. The apparatus embodiment corresponds to the method embodiment shown in FIG. 2, and the apparatus can be specifically applied to various electronic devices.

As shown in FIG. 7, the apparatus 70 for optimizing a voiceprint model based on reinforcement learning in this embodiment includes:
a data collection module 701, configured to collect historical recognition cases of a voiceprint model, and construct an optimization dataset according to the historical recognition cases;
an initialization module 702, configured to randomly initialize a policy network, sample audio data from the optimization dataset, input the audio data into the voiceprint model, and control the voiceprint model to perform voiceprint recognition according to an initialization policy, to obtain a recognition result and a corresponding reward value for each sample;
a policy update module 703, configured to calculate an advantage function according to the recognition result and the reward value for each sample, and perform parameter update on the policy network based on the advantage function;
a function optimization module 704, configured to optimize a pre-constructed objective function according to parameters of the policy network before and after the update, the objective function including a KL divergence term for constraining a policy update magnitude;
an iteration control module 705, configured to repeatedly execute the process of audio data sampling, voiceprint recognition, and policy update until the objective function satisfies a preset condition, to obtain an optimal policy network; and
a model optimization module 706, configured to control the voiceprint model to perform voiceprint recognition according to an optimal policy based on the optimal policy network, to optimize a recognition result.

The modules referred to in this application refer to a series of computer program instruction segments that can complete specific functions, and are more suitable for describing the execution process of optimizing a voiceprint model based on reinforcement learning than programs. Refer to the above corresponding method embodiments for the specific implementations of each module. Details are not described here.

In one embodiment, the data collection module 701 includes:
a case collection unit, configured to collect historical recognition cases of the voiceprint model from a business scenario, where the historical recognition cases include a successful recognition case set and a failed recognition case set; and
a preprocessing unit, configured to preprocess audio data in each historical recognition case, and construct the optimization dataset by using preprocessed audio data and corresponding historical model outputs as audio pairs.

In one embodiment, the initialization module 702 includes:
a sampling and input unit, configured to sample audio pairs from the optimization dataset, input the audio data in the audio pairs into the voiceprint model, and control the voiceprint model to recognize, according to the initialization policy, whether the audio data and corresponding reference audio belong to a same person, to obtain the recognition result for each sample.
a result determining unit, configured to determine whether the voiceprint model implements correct recognition currently according to the recognition result for each sample, a corresponding historical model output, and a case set to which the sample belongs; and
a reward unit, configured to provide a positive reward when the voiceprint model implements correct recognition, or provide a negative reward when the voiceprint model implements incorrect recognition, to obtain the corresponding reward value.

In one embodiment, the policy update module 703 includes:
a first calculation unit, configured to calculate a corresponding advantage function through generalized advantage estimation according to the recognition result and the reward value for each sample; and
a policy parameter update unit, configured to calculate a policy gradient according to the advantage function, and updating the parameters of the policy network according to the policy gradient.

In one embodiment, the function optimization module 704 includes:
a calling unit, configured to invoke the pre-constructed objective function, the objective function including the KL divergence term for constraining the policy update magnitude;
a second calculation unit, configured to calculate a ratio of probabilities of selecting an action by a new policy and an old policy respectively, and a KL divergence value according to the parameters of the policy network before the update and the parameters of the policy network after the update; and
an objective function update unit, configured to update a value of the objective function according to the ratio of probabilities, the advantage function, and the KL divergence value.

In one embodiment, the apparatus 70 further includes:
an obtaining module, configured to obtain pre-constructed validation set data;
a performance evaluation module, configured to evaluate performance of the voiceprint model by using the validation set data according to a preset evaluation policy; and
a dynamic adjustment module, configured to dynamically adjust, according to a performance evaluation result, a reward function for calculating the reward value.

In one embodiment, the dynamic adjustment module is specifically configured to:
correspondingly reduce a magnitude of a positive reward and increase a magnitude of a negative reward when the performance of the voiceprint model is improved; or
correspondingly increase the magnitude of the positive reward and reduce the magnitude of the negative reward when the performance of the voiceprint model is degraded.

In the above embodiment, this application discloses an apparatus for optimizing a voiceprint model based on reinforcement learning, where historical recognition cases of a voiceprint model are collected, and an optimization dataset is constructed according to the historical recognition cases; a policy network is randomly initialized, audio data is sampled from the optimization dataset, the audio data is inputted into the voiceprint model, and the voiceprint model is controlled to perform voiceprint recognition according to an initialization policy, to obtain a recognition result and a corresponding reward value for each sample; an advantage function is calculated according to the recognition result and the reward value for each sample, and parameter update is performed on the policy network based on the advantage function; a pre-constructed objective function is optimized according to parameters of the policy network before and after the update, the objective function including a KL divergence term for constraining a policy update magnitude; the process of audio data sampling, voiceprint recognition, and policy update is repeatedly executed until the objective function satisfies a preset condition, to obtain an optimal policy network; and the voiceprint model is controlled to perform voiceprint recognition according to an optimal policy based on the optimal policy network, to optimize a recognition result. The voiceprint model is optimized through reinforcement learning and KL divergence constraints, thereby improving stability and efficiency of policy update, reliably optimizing the voiceprint model, and improving recognition accuracy of the voiceprint model.

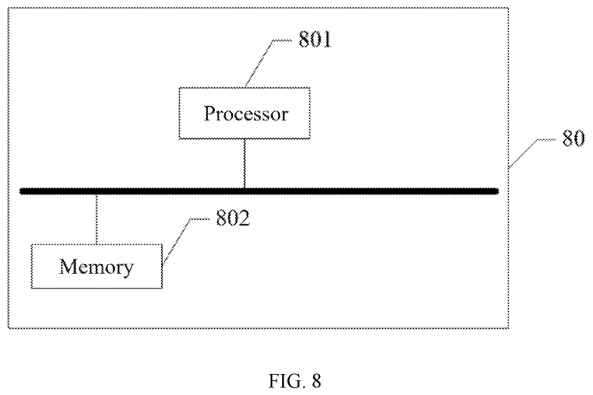

Another embodiment of this application provides a computer device. As shown in FIG. 8, a computer device 80 includes:
one or more processors 801 and a memory 802, with one processor 801 as an example in FIG. 8 for description. The processor 801 may be connected to the memory 802 by using a bus or another means, and the connection by using a bus is taken as an example in FIG. 8.

The processor 801 is configured to complete various control logic of the computer device 80, and may be a general-purpose processor, a digital signal processor (DSP), an application-specific integrated circuit (ASIC), a field programmable gate array (FPGA), a single-chip microcomputer, an Acorn RISC machine (ARM) or another programmable logic device, a discrete gate or transistor logic, a discrete hardware component, or any combination thereof. Additionally, the processor 801 may alternatively be any conventional processor, microprocessor or state machine. The processor 801 may alternatively be implemented as a combination of computing devices, for example, a combination of a DSP and a microprocessor, a plurality of microprocessors, one or more microprocessors in combination with a DSP, and/or any other such configuration.

As a nonvolatile computer-readable storage medium, the memory 802 may be configured to store nonvolatile software programs, nonvolatile computer-executable programs and modules, such as program instructions corresponding to the method for optimizing a voiceprint model based on reinforcement learning in the embodiment of this application. The processor 801 executes various functional applications and data processing of the computer device 80 by running nonvolatile software programs, instructions, and units stored in the memory 802, that is, the method for optimizing a voiceprint model based on reinforcement learning in the above method embodiment is implemented.

The memory 802 may include a program storage area and a data storage area. The program storage area may store an operating system and an application required by at least one function. The data storage area may store data created according to the use of the computer device 80, and the like. In addition, the memory 802 may include a high-speed random access memory, and may further include a non-volatile memory, such as at least one magnetic disk storage device, a flash memory device, or another nonvolatile solid-state storage device. In some embodiments, the memory 802 optionally includes memories remotely arranged relative to the processor 801, and these remote memories may be connected to the computer device 80 via a network. Examples of the above network include, but are not limited to, Internet, intranet, a local area network, a mobile communication network, and a combination thereof. One or more units are stored in the memory 802, and when executed by one or more processors 801, perform the steps of the method for optimizing a voiceprint model based on reinforcement learning in any of the above method embodiments.

In the above embodiment, this application discloses a computer device, where historical recognition cases of a voiceprint model are collected, and an optimization dataset is constructed according to the historical recognition cases; a policy network is randomly initialized, audio data is sampled from the optimization dataset, the audio data is inputted into the voiceprint model, and the voiceprint model is controlled to perform voiceprint recognition according to an initialization policy, to obtain a recognition result and a corresponding reward value for each sample; an advantage function is calculated according to the recognition result and the reward value for each sample, and parameter update is performed on the policy network based on the advantage function; a pre-constructed objective function is optimized according to parameters of the policy network before and after the update, the objective function including a KL divergence term for constraining a policy update magnitude; the process of audio data sampling, voiceprint recognition, and policy update is repeatedly executed until the objective function satisfies a preset condition, to obtain an optimal policy network; and the voiceprint model is controlled to perform voiceprint recognition according to an optimal policy based on the optimal policy network, to optimize a recognition result. The voiceprint model is optimized through reinforcement learning and KL divergence constraints, thereby improving stability and efficiency of policy update, reliably optimizing the voiceprint model, and improving recognition accuracy of the voiceprint model.

Another embodiment of this application provides a nonvolatile computer-readable storage medium, which may be nonvolatile or volatile, where the computer-readable storage medium stores computer-executable instructions, and the computer-executable instructions, when executed by one or more processors, execute the steps of the method for optimizing a voiceprint model based on reinforcement learning according to any one of the above method embodiments.

In the above embodiment, this application discloses a nonvolatile computer-readable storage medium, where historical recognition cases of a voiceprint model are collected, and an optimization dataset is constructed according to the historical recognition cases; a policy network is randomly initialized, audio data is sampled from the optimization dataset, the audio data is inputted into the voiceprint model, and the voiceprint model is controlled to perform voiceprint recognition according to an initialization policy, to obtain a recognition result and a corresponding reward value for each sample; an advantage function is calculated according to the recognition result and the reward value for each sample, and parameter update is performed on the policy network based on the advantage function; a pre-constructed objective function is optimized according to parameters of the policy network before and after the update, the objective function including a KL divergence term for constraining a policy update magnitude; the process of audio data sampling, voiceprint recognition, and policy update is repeatedly executed until the objective function satisfies a preset condition, to obtain an optimal policy network; and the voiceprint model is controlled to perform voiceprint recognition according to an optimal policy based on the optimal policy network, to optimize a recognition result. The voiceprint model is optimized through reinforcement learning and KL divergence constraints, thereby improving stability and efficiency of policy update, reliably optimizing the voiceprint model, and improving recognition accuracy of the voiceprint model.

By the description of the above implementations, a person skilled in the art can clearly understand that the method in the above-mentioned embodiments may be implemented by software and a necessary general-purpose hardware platform, or definitely, by hardware, but the former is a better implementation in many cases. Based on this understanding, the technical solution of this application essentially, or a part contributing to the prior art, may be embodied in a form of a software product. The computer software product is stored on a storage medium (for example, an ROM/RAM, a magnetic disk, and a compact disc), and includes a plurality of instructions configured to cause a terminal device (which may be a mobile phone, a computer, a server, an air-conditioner, a network device, or the like) to perform the method according to each embodiment of this application.

This application can be used in a variety of general-purpose or special-purpose computer system environments or configurations, for example, personal computers, server computers, handheld or portable devices, tablet devices, multiprocessor systems, microprocessor-based systems, set-top boxes, programmable consumer electronic devices, network PCs, minicomputers, mainframe computers, and distributed computing environments including any of the above systems or devices. This specification can be described in the general context of computer-executable instructions, for example, a program module. Generally, the program module includes a routine, a program, an object, a component, a data structure, etc. for executing a specific task or implementing a specific abstract data type. This specification may alternatively be practiced in distributed computing environments in which tasks are performed by remote processing devices that are connected via a communication network. In the distributed computing environment, a program module may be located in local and remote computer storage media including a storage device.

To sum up, in the method and apparatus for optimizing a voiceprint model based on reinforcement learning, the device, and the medium disclosed in this application, the method includes: collecting historical recognition cases of a voiceprint model, and constructing an optimization dataset according to the historical recognition cases; randomly initializing a policy network, sampling audio data from the optimization dataset, inputting the audio data into the voiceprint model, and controlling the voiceprint model to perform voiceprint recognition according to an initialization policy, to obtain a recognition result and a corresponding reward value for each sample; calculating an advantage function according to the recognition result and the reward value for each sample, and performing parameter update on the policy network based on the advantage function; optimizing a pre-constructed objective function according to parameters of the policy network before and after the update, the objective function including a KL divergence term for constraining a policy update magnitude; repeatedly executing the process of audio data sampling, voiceprint recognition, and policy update until the objective function satisfies a preset condition, to obtain an optimal policy network; and controlling the voiceprint model to perform voiceprint recognition according to an optimal policy based on the optimal policy network, to optimize a recognition result. The voiceprint model is optimized through reinforcement learning and KL divergence constraints, thereby improving stability and efficiency of policy update, reliably optimizing the voiceprint model, and improving recognition accuracy of the voiceprint model.

Definitely, those of ordinary skill in the art may understand that all or some of the processes in the method of the foregoing embodiments may be completed by a computer program instructing related hardware (such as a processor and a controller). The computer program may be stored in a nonvolatile computer-readable storage medium. The computer program, when executed, may include processes of the above-mentioned method embodiments. The storage medium may be a memory, a magnetic disk, a floppy disk, a flash memory, an optical memory, or the like.

It should be noted that if any software tools or components not belonging to the company appear in the embodiments of this application, they are provided merely for illustrative purposes and do not represent actual use. It should be understood that the application of this application is not limited to the above-mentioned examples, and for a person of ordinary skill in the art, improvements or modifications may be made according to the above-mentioned descriptions, and all these improvements and modifications shall fall within the protection scope of the appended claims of this application.

What is claimed is:

1. A method for optimizing a voiceprint model based on reinforcement learning, comprising:
collecting historical recognition cases of a voiceprint model, and constructing an optimization dataset according to the historical recognition cases;
randomly initializing a policy network, sampling audio data from the optimization dataset, inputting the audio data into the voiceprint model, and controlling the voiceprint model to perform voiceprint recognition according to an initialization policy, to obtain a recognition result and a corresponding reward value for each sample;
calculating an advantage function according to the recognition result and the reward value for each sample, and performing parameter update on the policy network based on the advantage function;
optimizing a pre-constructed objective function according to parameters of the policy network before and after the update, the objective function comprising a KL divergence term for constraining a policy update magnitude;
repeatedly executing the process of audio data sampling, voiceprint recognition, and policy update until the objective function satisfies a preset condition, to obtain an optimal policy network; and
controlling the voiceprint model to perform voiceprint recognition according to an optimal policy based on the optimal policy network, to optimize a recognition result.

2. The method for optimizing a voiceprint model based on reinforcement learning according to claim 1, wherein the collecting historical recognition cases of a voiceprint model, and constructing an optimization dataset according to the historical recognition cases comprises:
collecting historical recognition cases of the voiceprint model from a business scenario, wherein the historical recognition cases comprise a successful recognition case set and a failed recognition case set; and
preprocessing audio data in each historical recognition case, and constructing the optimization dataset by using preprocessed audio data and corresponding historical model outputs as audio pairs.

3. The method for optimizing a voiceprint model based on reinforcement learning according to claim 2, wherein the sampling audio data from the optimization dataset, inputting the audio data into the voiceprint model, and controlling the voiceprint model to perform voiceprint recognition according to an initialization policy, to obtain a recognition result and a corresponding reward value for each sample comprises:
sampling audio pairs from the optimization dataset, inputting the audio data in the audio pairs into the voiceprint model, and controlling the voiceprint model to recognize, according to the initialization policy, whether the audio data and corresponding reference audio belong to a same person, to obtain the recognition result for each sample;
determining whether the voiceprint model implements correct recognition currently according to the recognition result for each sample, a corresponding historical model output, and a case set to which the sample belongs; and
providing a positive reward when the voiceprint model implements correct recognition, or providing a negative reward when the voiceprint model implements incorrect recognition, to obtain the corresponding reward value.

4. The method for optimizing a voiceprint model based on reinforcement learning according to claim 3, wherein the determining whether the voiceprint model implements correct recognition currently comprises:
determining that the recognition is correct, if a current recognition result is consistent with the historical model output, and the sample belongs to the successful recognition case set; or
determining that the recognition is incorrect, if the current recognition result is inconsistent with the historical model output, and the sample belongs to the successful recognition case set; or
determining that the recognition is incorrect, if the current recognition result is consistent with the historical model output, and the sample belongs to the failed recognition case set; or
determining that the recognition is correct, if the current recognition result is inconsistent with the historical model output, and the sample belongs to the failed recognition case set.

5. The method for optimizing a voiceprint model based on reinforcement learning according to claim 1, wherein the calculating an advantage function according to the recognition result and the reward value for each sample, and performing parameter update on the policy network based on the advantage function comprises:
calculating a corresponding advantage function through generalized advantage estimation according to the recognition result and the reward value for each sample; and
calculating a policy gradient according to the advantage function, and updating the parameters of the policy network according to the policy gradient.

6. The method for optimizing a voiceprint model based on reinforcement learning according to claim 5, wherein during the updating of the parameters of the policy network according to the policy gradient, the method further comprises:
controlling a step size of the parameter update of the policy network by using a learning rate.

7. The method for optimizing a voiceprint model based on reinforcement learning according to claim 1, wherein the optimizing a pre-constructed objective function according to the parameters of the policy network before and after the update, the objective function comprising a KL divergence term for constraining a policy update magnitude comprises:
invoking the pre-constructed objective function, the objective function comprising the KL divergence term for constraining the policy update magnitude;
calculating a ratio of probabilities of selecting an action by a new policy and an old policy respectively, and a KL divergence value according to the parameters of the policy network before the update and the parameters of the policy network after the update; and
updating a value of the objective function according to the ratio of probabilities, the advantage function, and the KL divergence value.

8. The method for optimizing a voiceprint model based on reinforcement learning according to claim 1, further comprising:
obtaining pre-constructed validation set data;
evaluating performance of the voiceprint model by using the validation set data according to a preset evaluation policy; and
dynamically adjusting, according to a performance evaluation result, a reward function for calculating the reward value.

9. The method for optimizing a voiceprint model based on reinforcement learning according to claim 8, further comprising:
evaluating performance of the voiceprint model on the validation set data according to a fixed time period.

10. The method for optimizing a voiceprint model based on reinforcement learning according to claim 8, further comprising:
obtaining a data processing amount of the voiceprint model; and
evaluating performance of the voiceprint model on the validation set data when the data processing amount reaches a preset number.

11. The method for optimizing a voiceprint model based on reinforcement learning according to claim 8, wherein the evaluating performance of the voiceprint model by using the validation set data according to a preset evaluation policy comprises:
inputting the validation set data into the voiceprint model for recognition to obtain a recognition result of the validation set data; and
calculating evaluation metrics according to the recognition result of the validation set data, wherein the evaluation metrics comprise at least one of accuracy, recall and F1 score.

12. The method for optimizing a voiceprint model based on reinforcement learning according to claim 8, wherein the dynamically adjusting, according to a performance evaluation result, a reward function for calculating the reward value specifically comprises:
correspondingly reducing a magnitude of a positive reward and increasing a magnitude of a negative reward when the performance of the voiceprint model is improved; or
correspondingly increasing the magnitude of the positive reward and reducing the magnitude of the negative reward when the performance of the voiceprint model is degraded.

13. A computer device, comprising at least one processor; and
a memory in communication connection with the at least one processor, wherein
the memory stores instructions executable by the at least one processor, and the instructions are executed by the at least one processor, to enable the at least one processor to perform the following steps of a method for optimizing a voiceprint model based on reinforcement learning:
collecting historical recognition cases of a voiceprint model, and constructing an optimization dataset according to the historical recognition cases;
randomly initializing a policy network, sampling audio data from the optimization dataset, inputting the audio data into the voiceprint model, and controlling the voiceprint model to perform voiceprint recognition according to an initialization policy, to obtain a recognition result and a corresponding reward value for each sample;
calculating an advantage function according to the recognition result and the reward value for each sample, and performing parameter update on the policy network based on the advantage function;
optimizing a pre-constructed objective function according to parameters of the policy network before and after the update, the objective function comprising a KL divergence term for constraining a policy update magnitude;
repeatedly executing the process of audio data sampling, voiceprint recognition, and policy update until the objective function satisfies a preset condition, to obtain an optimal policy network; and
controlling the voiceprint model to perform voiceprint recognition according to an optimal policy based on the optimal policy network, to optimize a recognition result.

14. The computer device according to claim 13, wherein the collecting historical recognition cases of a voiceprint model, and constructing an optimization dataset according to the historical recognition cases comprises:
collecting historical recognition cases of the voiceprint model from a business scenario, wherein the historical recognition cases comprise a successful recognition case set and a failed recognition case set; and
preprocessing audio data in each historical recognition case, and constructing the optimization dataset by using preprocessed audio data and corresponding historical model outputs as audio pairs.

15. The computer device according to claim 14, wherein the sampling audio data from the optimization dataset, inputting the audio data into the voiceprint model, and controlling the voiceprint model to perform voiceprint recognition according to an initialization policy, to obtain a recognition result and a corresponding reward value for each sample comprises:
sampling audio pairs from the optimization dataset, inputting the audio data in the audio pairs into the voiceprint model, and controlling the voiceprint model to recognize, according to the initialization policy, whether the audio data and corresponding reference audio belong to a same person, to obtain the recognition result for each sample;
determining whether the voiceprint model implements correct recognition currently according to the recognition result for each sample, a corresponding historical model output, and a case set to which the sample belongs; and
providing a positive reward when the voiceprint model implements correct recognition, or providing a negative reward when the voiceprint model implements incorrect recognition, to obtain the corresponding reward value.

16. The computer device according to claim 15, wherein the determining whether the voiceprint model implements correct recognition currently comprises:
determining that the recognition is correct, if a current recognition result is consistent with the historical model output, and the sample belongs to the successful recognition case set; or
determining that the recognition is incorrect, if the current recognition result is inconsistent with the historical model output, and the sample belongs to the successful recognition case set; or
determining that the recognition is incorrect, if the current recognition result is consistent with the historical model output, and the sample belongs to the failed recognition case set; or
determining that the recognition is correct, if the current recognition result is inconsistent with the historical model output, and the sample belongs to the failed recognition case set.

17. The computer device according to claim 13, wherein the calculating an advantage function according to the recognition result and the reward value for each sample, and performing parameter update on the policy network based on the advantage function comprises:
calculating a corresponding advantage function through generalized advantage estimation according to the recognition result and the reward value for each sample; and
calculating a policy gradient according to the advantage function, and updating the parameters of the policy network according to the policy gradient.

18. The computer device according to claim 13, wherein the optimizing a pre-constructed objective function according to the parameters of the policy network before and after the update, the objective function comprising a KL divergence term for constraining a policy update magnitude comprises:
invoking the pre-constructed objective function, the objective function comprising the KL divergence term for constraining the policy update magnitude;
calculating a ratio of probabilities of selecting an action by a new policy and an old policy respectively, and a KL divergence value according to the parameters of the policy network before the update and the parameters of the policy network after the update; and
updating a value of the objective function according to the ratio of probabilities, the advantage function, and the KL divergence value.

19. The computer device according to claim 13, further comprising:
obtaining pre-constructed validation set data;
evaluating performance of the voiceprint model by using the validation set data according to a preset evaluation policy; and
dynamically adjusting, according to a performance evaluation result, a reward function for calculating the reward value.

20. A nonvolatile computer-readable storage medium, wherein the nonvolatile computer-readable storage medium stores computer-executable instructions and the computer-executable instructions, when executed by one or more processors, cause the one or more processors to perform the method for optimizing a voiceprint model based on reinforcement learning according to claim 1.
